(19) United States
(12) Patent Application Publication
(10) Pub. No.: US 2020/0331495 A1
(43) Pub. Date: Oct. 22, 2020

(54) SYSTEM FOR STEERING AN AUTONOMOUS VEHICLE

(71) Applicant: INSTITUT VEDECOM, Versailles (FR)

(72) Inventor: Annie BRACQUEMOND, Gif Sur Yvette (FR)

(73) Assignee: Institut Vedecom, Versailles (FR)

(21) Appl. No.: 16/320,780

(22) PCT Filed: Jul. 25, 2017
(86) PCT No.: PCT/FR2017/052049

§ 371 Date: Jan. 25, 2019

(30) Foreign Application Priority Data
Jul. 29, 2016 (FR) 1657337

(51) Int. Cl. B60W 60/00; B60W 30/095; G01C 21/34; G01C 21/36; G01S 19/42

(52) U.S. Cl. CPC B60W 60/0016; B60W 60/0025; B60W 30/095; G01C 21/3407; B60W 2555/60; G01S 19/42; B60W 2530/14; B60W 2552/00; G01C 21/3691

(57) ABSTRACT

The present invention relates to a system for steering an autonomous vehicle comprising a plurality of sensors (1 to 6) of different natures, calculators executing computer programs for determining items of information regarding delegated driving as a function of the data delivered by said sensors, characterized in that it furthermore comprises at least one arbitration module (15) comprising at least one calculator executing a computer program to decide the safest functional selection of one of said items of information regarding delegated driving as a function of a plurality of items of information calculated as a function: ⋅ of dynamic data comprising part at least of the items of information consisting of: ⋅ confidence levels (44) of each of said items of information of delegated driving, ⋅ of the coherence (45) of variables associated with said delegated items of information ⋅ of the hardware and software reliability (46) of the components of said system ⋅ of climatic and/or historical data comprising part at least of the items of information consisting of: ⋅ the driving history of the vehicle (48), ⋅ environmental conditions (49), ⋅ and of decision processings for the arbitration of a safe behaviour (47) of the steering.

### CROSS-REFERENCE TO RELATED APPLICATIONS

This application is the US National Stage under 35 USC § 371 of International App. No. PCT/FR2017/052049 filed Jul. 25, 2017, which in turn claims the priority of French application 1657337 filed on Jul. 29, 2016, the content of which (text, drawings and claims) is incorporated here by reference.

### BACKGROUND

### Field of the Invention

The present invention concerns the field of autonomous vehicles and more specifically computerized equipment intended to control autonomous vehicles.

A vehicle is classified as autonomous if it can be moved without the continuous intervention and oversight of a human operator. According to the United States Department of Transportation, this means that the automobile can operate without a driver intervening for steering, accelerating or braking. Nevertheless, the level of automation of the vehicle remains the most important element. The National Highway Traffic Safety Administration (the American administration responsible for Highway traffic safety) thus defines five “levels” of automation:
Level 0: No automation. The driver has total control at all times of the principal functions of the vehicle (motor, accelerator, steering, brakes).
Level 1: Automation of certain functions. There is automation for certain functions of the vehicle, but only to assist the driver who maintains overall control. For example, the anti-lock braking system (ABS) or electronic stability program (ESP) will automatically act on the braking to help the driver maintain control of the vehicle.
Level 2: Automation of combined functions. The control of at least two principal functions is combined in the automation to replace the driver in certain situations. Cruise control combined with lane centering puts the vehicle in this category, as does parking assist which enables parking without the driver acting on the steering wheel or pedals.
Level 3: Limited autonomous steering. The driver can cede complete control of the vehicle to the automated system which will then be responsible for the critical safety functions. However, autonomous steering can only take place under certain environmental and traffic conditions (only on the highway, for example). The driver is required to be in position to retake control within an acceptable amount of time upon demand from the system (particularly when the autonomous traffic conditions are no longer met: leaving the highway, congestion, etc.). The Google Car (commercial name) is currently in this stage of automation.
Level 4: Complete autonomous driving. The vehicle is designed so that it alone provides all the critical safety functions over a complete route. The driver provides a destination or navigation instructions but is not required to be available to retake control. Moreover, he can leave the driver's seat and the vehicle is capable of driving with no occupant on board.

Driverless vehicles operate by accumulating multiple items of information provided by cameras, sensors, geo-positioning devices (including radar), digital maps, programming and navigation systems, as well as data transmitted by other connected vehicles and networked infrastructures. The operating systems and the software then process all this information and provide coordination of the mechanical functions of the vehicle. These methods reproduce the infinite complexity of tasks carried out by a driver who is required, in order to drive properly, to concentrate on the road, the behavior of his vehicle as well as his own behavior.

The computer architecture of such vehicles must make it possible to manage the multitude of signals produced by sensors and outside sources of information and to process them to extract pertinent data from the signals, eliminating abnormal data and combining data to control the electromechanical members of the vehicle (steering, braking, engine speed, alarms, etc.).

Because of the context of usage, the computer architecture must guarantee absolute reliability, even in the event of error on a digital card, a failed sensor or malfunction of the navigation software, or all three of these elements at the same time.

The mechanisms to ensure the robustness of the architectures include:
control of coherence and integrity of the confidence levels of each perception subsystem,
ensuring the reliability of each subsystem in order to limit the failure rate,
redundancies of physical calculation media, and
functional redundancies distributed over different physical media.

### Prior Art

Different solutions of computer architectures intended for autonomous vehicles have been proposed in the prior art.

WO 2014044480 describes a method for operating an automotive vehicle in an automatic driving mode, comprising the steps of:
determining a standard trajectory (ST1), the determined standard trajectory (ST1) being transmitted by means of a control device to an actuator device of the automotive vehicle during driving;
guiding the automotive vehicle along the standard trajectory (ST1); and
determining a safe range (B) for the automotive vehicle, the determined safe range (B) being transmitted by the control device to the actuator device (1) during driving;

in a case where the automatic driving of the automotive vehicle is no longer guaranteed, to change over to the safe range (B), the automotive vehicle being guided by the actuator device into the safe range (B).

US 20050021201 describes a method and device for the exchanging and common processing of object data between sensors and a processing unit. According to this prior art solution, position information and/or speed information and/or other attributes (dimension, identification, references) of sensor objects and fusion objects are transmitted and processed.

US 20100104199 describes a method for detecting an available travel path for a host vehicle, by clear path detection by image analysis and detection of an object within an environment of the host vehicle. This solution includes camera-based monitoring, analysis of the image by path detection, analysis to determine a clear path of movement in the image, the monitoring of data from the sensor describing the object, the analysis of the data from the sensor for determining the impact of the object on the path.

U.S. Pat. No. 8,930,060 describes an environment analysis system from a plurality of sensors for detecting predetermined safety risks associated with a plurality of potential destination regions around a vehicle when the vehicle is moving on a road. The system selects one of the potential destination regions as a target area having a substantially lower safety risk. A path determination unit assembles a plurality of plausible paths between the vehicle and the target area, monitors the predetermined safety risks associated with a plurality of plausible paths, and selects one of the plausible paths having a substantially lower risk as a target path. An impact detector detects an impact between the vehicle and another object. A stability control is configured to orient the vehicle autonomously over the target path when the impact is detected.

EP 2865575 describes a driving assistance system comprising a prediction subsystem in a vehicle. The method comprises the steps consisting of accepting an environment representation. The calculation of a confidence estimate is related to the representation of the environment by applying the plausibility rules to the representation of the environment and by furnishing the confidence estimate as contribution for an evaluation of a prediction based on the representation of the environment.

### Disadvantages of the Prior Art

The solutions of the prior art are not completely satisfactory because the proposed architectures involve a “linear” processing of data, coming from sensors and disparate sources, some of which are potentially erroneous or flawed. With the proposed architectures, the processing of such erroneous or doubtful data is deterministic and can lead to unexpected actions.

The solutions proposed in the prior art are not completely adapted to the very high safety constraints for steering autonomous vehicles.

The environment of the vehicle, including meteorological and atmospheric aspects among others, as well as the road environment, is replete with disturbances.

It includes numerous factors that are random and therefore unpredictable, and the safety constraints resulting from these environmental disturbances have an infinite number of variants. For example, meteorological conditions can disturb the sensors, but the context or the road situation can also put the algorithm in a position it cannot or does not know how to manage. The limits of a sensor are known, but all the situations in which the sensors and their intelligence will reach their limits is unknown.

The proposed solutions do not involve an intelligent decision stage based on functional safety as well as dysfunctional at the same time, without human intervention.

### BRIEF SUMMARY

### Solution Provided by the Invention

In order to remedy these disadvantages, according to its most general meaning the invention concerns a system for steering an autonomous vehicle according to claim 1 and the dependent claims, as well as a steering method according to the method claim.

Compared to the known solutions, the system is distinguished by independent functional redundancies detailed in the following list, arbitrated by an additional decision module implementing the safety of the intended functionality (SOTIF) principles.

This arbitration takes into account three types of input information:
on the one hand, a diversity of dynamic data, i.e. those related to the position and trajectory of the vehicle and to the perception of obstacles,
and on the other hand, historical data, which are not directly related to the dynamic data, for example environmental and weather disturbances, the history of the trajectory and/or of the behavior of the autonomous vehicle and safe behavior principles.

These safety principles are technically implemented by a rules base recorded in a computer memory. These rules model good practices, for example “stop to allow a pedestrian to pass” or “do not exceed maximum authorized speed” and associate decision-making parameters. For example, these rules are grouped within the standard ISO 26262.

This rules base is utilized by a processor modifying the calculation of the risk level, and the consequence on the technical choices.

The system makes it possible to respond to the disadvantages of the prior art by a distributed architecture, with specialized computers assigned solely to processing data from sensors, computers of another type specifically assigned to the execution of computer programs for the determination of delegated driving information, and an additional computer constituting the arbitration module for deciding the selection of the said delegated driving information.

The decision of the arbitration module enables the safest result to be identified for any type of object perceived in the scene (status of a traffic light, position of an obstacle, location of the vehicle, distance relative to a pedestrian, maximum authorized speed on the road, etc.).

Any disturbances and anomalies concerning a sensor or a data source is therefore not propagated into all the systems. With the proposed architecture, the system has great flexibility and robustness with regard to local malfunctions.

The arbitration module can consist of a computer applying processing from a mathematical logic rules base and artificial intelligence, or by applying statistical processing (for example Monte Carlo, Gibbs, Bayesian, etc.) or machine learning. This processing makes it possible to ensure both real-time processing, and parallel tasks processing to be subsequently reinjected into the real-time processing.

Also disclosed is a method of steering an autonomous vehicle comprising:
steps of acquiring a plurality of items of information by sensors,
steps of processing said acquired information for determination of delegated driving information,
steps of acquisition of environmental conditions,
steps of calculating representative items of information
   confidence levels of each of said delegated driving items of information,
   coherence of variables associated with said delegated items of information,
   reliability of the hardware and software components of the said system
steps of deciding optimal delegated driving items of information in terms of reliability and safety of persons, as a function of a plurality of items of information from the results of the steps of calculating the said representative items of information, driving history of the vehicle and safety standards rules (road safety, good practices, level of safety risks of life situations).

### DESCRIPTION OF THE FIGURES

The present invention will be better understood from the following detailed description of a non-limiting example of the invention, with reference to the appended drawings in which:

FIG. 1 represents a schematic view of a first example of the architecture of a driving system of an autonomous vehicle; and

FIG. 2 represents a schematic view of a second example of the architecture of a driving system of an autonomous vehicle.

### DETAILED DESCRIPTION

### First embodiment

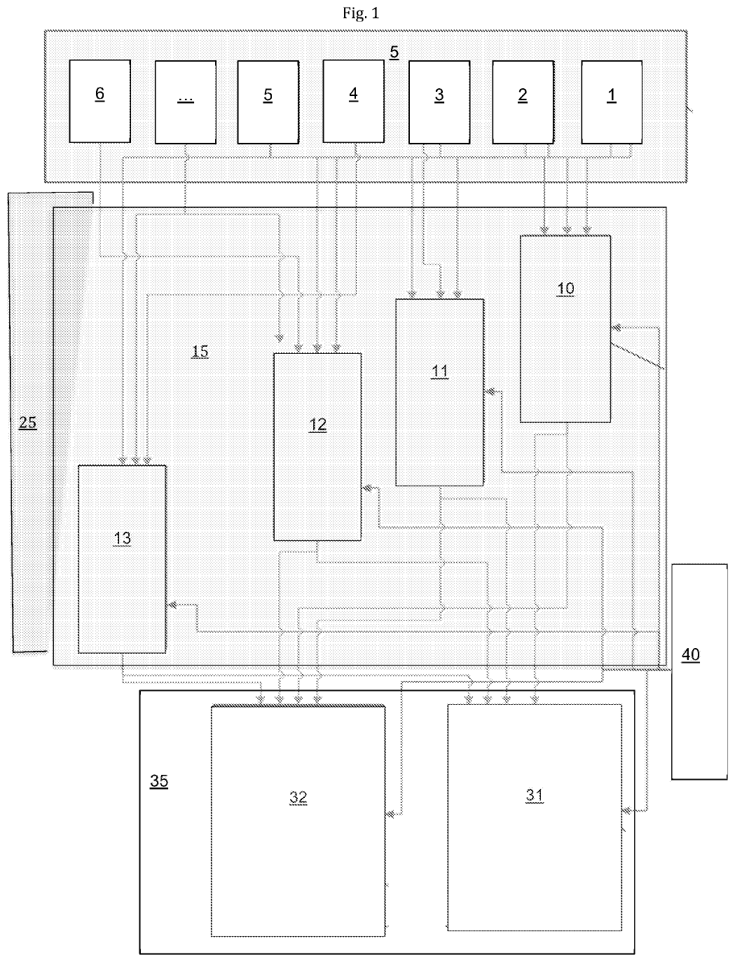

The computer architecture illustrated in FIG. 1 comprises:
a first data production stage comprising:
   a plurality of onboard sensors (1 to 3),
   a plurality of connected components (11 to 13) communicating with outside information sources,
a second stage of direct operational use of the data, comprising hyper-perception modules each comprising input ports of signals from a plurality of connected sensors and components and a computer executing a hyper-perception of objects program, for performing the functions of:
   perception that allow the vehicle to interpret its environment and to perceive static or dynamic objects;
   positioning that allows the vehicle to be located on a map;
a third stage of utilization of the signals delivered by the hyper-perception modules comprising:
   a nominal hyper-planning module (31) performing the function of planning that makes it possible to calculate the lateral and longitudinal trajectory that the vehicle should follow by calculating a set of steering orders,
   a standby hyper-planning module (32) calculating a fallback solution in order to place the vehicle in safety even in the most critical contexts.

All the processing is declarative and non-deterministic: at any time, the items of information used and calculated are associated with confidence levels the value of which is only known during the execution of the programs.

Four robustness mechanisms are implemented:
Intrinsic redundancies for the physical computing media as well as the processing modules: these redundancies lead to coherence tests that can result in majority votes;
Functional redundancies conditioned (by environmental conditions) and weighted (by confidence levels) for the production of data and intermediate results;
Functional redundancies for the production of calculation results of trajectories;
Centralized utilization of cross-referenced and cross-checked items of information for a safe supervision strategy and intelligent decision.

The system implements the following technical choices
Implementation in the first stage (5) of a diversity of sensors, and functional perception redundancies in the second stage (15) in order to perceive the same object in different ways. In this way, cross-tests can be performed on these perception results—as concerns reliability, coherence and associated confidence
in order to make comparisons from the point of view of these different criteria and to choose the best perception result.
Utilization, in the third stage (25), of the diversity of planning means, which in turn are supplied by the perception results, in order to define a plurality of possible trajectories. In this way, cross-tests can also be performed on these trajectories—as concerns reliability, coherence and associated confidence—in order to make comparisons from the point of view of these different criteria and to choose the best trajectories.
Utilization of the diversity of planning means to provide all the possible fallback possibilities in case of emergency, i.e. the definition of refuge trajectories. This is hyper-planning of refuge.
Matching driving context of the vehicle (i.e. the obstacles, infrastructure, history, etc.) with the best trajectories in order to follow the safest trajectory.

In this way, the system of the autonomous vehicle tends to be more reliable by using a maximum of these technological and functional capabilities. However, it also becomes more tolerant to failures because it is capable of detecting them and safeguarding against them by continually adapting its behavior.

### First Stage

The first stage (5) comprises the modules (1 to 3) for processing signals from different sensors onboard the vehicle and the connected modules (4 to 6) receiving external data.

A plurality of sensors and sources detect the same object. The merging of these data make it possible to confirm the perception.

The sources of the autonomous vehicle are a multiple base for detection of the environment. Each sensor and each source is associated with an item of information representative of the reliability and confidence level.

The detection results are then processed in order to be useable by the second stage: production of perception variables.

### Second stage

The hyper-perception stage (15) is broken down into two parts:

The “Production of perception variables” part, grouping together all the perception algorithms that interpret the detections from the sensors and other sources and calculate perception variables representative of an object.

The “Safe supervision” part that groups together a set of cross-tests on reliabilities, software and hardware errors, confidence levels, and algorithmic coherences. This all makes it possible to determine the most competitive object of perception, i.e. the object that is best in terms of representativity, confidence, reliability and integrity.

From these detection results and via numerous algorithms, perception variables are calculated. These variables will allow the system to describe the objects of the scene and thus to define a safe trajectory for the vehicle.

In order to be able to satisfy the safety methodology, an object perception variable should be given by at least two different algorithms. A merger of multi-sources, when possible, should also be used to produce these variables.

When combined in an intelligent algorithm, all the merger methods involving a plurality of sensors or other sources can improve the different perception variables. All the object perception variables are then cross checked to test their validity and the confidence level that can be assigned to them. This is the third step.

At this stage, a plurality of sets of variables representative of the same object have been calculated. They must therefore be compared to each other in order to be able to select the “best” one or ones.

This selection is carried out in four steps:
Sorting the confidence levels that enables the variables to be ranked from the correlation of the source/algorithm confidence levels and environmental conditions. This test will therefore also consider both the confidence level of the algorithm that has calculated the variable(s) as well as the confidence level of the source(s) thereof. This involves answering the question: which variables are of the best quality, and which ones appear the most sure?
Processing the reliability that makes it possible to ensure that all the elements leading to the perception of an object are intrinsically reliable. This analysis will then consider the reliability of all the hardware and software elements. This involves answering the question: Are the perceived objects reliable in accordance with the principles of operating safety?
The analysis of the algorithmic coherence that compares the different variables of the perception objects to each other and identifies potential incoherencies. This analysis reveals an incoherent or meaningless variable. This involves answering the question: Which variables have the maximum coherence in order to eliminate those that have the least coherence?

The computer executes processing that synthesizes all the results and decides on the best object to send to the planning. This involves answering the question: What are the best objects in terms of coherence, reliability and confidence?

This second stage is duplicated from the hardware point of view (computers and communication bus) as well as from the software point of view.

It therefore comprises two independent computers, receiving the signals from the sensors of the first stage by means of two different communication buses.

This second stage transmits the same data two times to the third stage.

### Third Stage

The third hyper-planning stage (35) comprises two planning modules (31, 32) for steering the autonomous vehicle.

The planning process is broken down into three different parts:
The “Hyper-perception modules” part, which groups together all the functions, hyper-perceptions associated with each perception function, as well as other input modules such as map files that enable location results to be compared to information known otherwise, and thus to calculate a trajectory for the autonomous vehicle.
The “Production of trajectories” part, which groups together all the planning algorithms and which calculates the different trajectories that the autonomous vehicle can take. This trajectory calculation is based on the perception functions of the vehicle's environment.
The “Safety supervision and intelligent decision” part, which groups together a set of cross-tests on the reliabilities, confidence levels, and algorithmic coherences. These all make it possible to determine the most competitive trajectory—i.e. the trajectory which, in terms of representativity, confidence, reliability, and integrity—is the best.

This part receives both series of signals from the second stage and decides on the hardware and software reliability of the two series of signals in order to select the most pertinent series of signals.

A plurality of algorithms calculates the trajectories that the autonomous vehicle can take. Each algorithm calculates one type of trajectory specific to the perception objects that it considers. However, it can calculate one or more trajectories of the same type depending on the number of paths that the vehicle can potentially take. For example, if the vehicle is moving over a two-lane road segment, the planning system can calculate a trajectory for each lane.

In order to satisfy the safety methodology utilized, the algorithms calculating trajectories must send the potential trajectory(ies) accompanied by the confidence level and intrinsic reliability associated therewith. Another specific aspect of the safety methodology is to use a multi-perception merger algorithm in order to diversify even more the trajectory calculation means.

At this stage, multiple trajectories have been calculated. They must be compared to each other and to the road context (rules of the road, history, infrastructures, obstacles, navigation) in order to be prioritized.

This prioritization takes place in four steps:
Sorting the confidence levels, which orients the choice of the trajectory only from the correlation existing between the source/algorithm confidence levels and the environmental conditions. This test will therefore also consider the confidence level of the algorithm that has calculated the trajectory as well as the confidence level of the source thereof. This involves the question: what is the best quality trajectory in terms of confidence level?
Verification of reliability, which ensures that all the elements leading to the definition of a trajectory are intrinsically reliable. This analysis will therefore consider the reliability of all the electronic circuits and the computer processing. This involves answering the question: Does the calculated trajectory conform to the principles of operational safety?
Analysis of the algorithmic coherence, which compares the trajectories to each other and identifies any incoherencies. This analysis reveals a trajectory that could be incoherent or meaningless. This involves answering the question: Which trajectory has the greatest coherence?
Intelligent safety decision, which synthesizes all the results and decides the best trajectory(ies), in terms of safety of persons in a given living situation. It must therefore answer the question: what is the best trajectory the vehicle can take while guaranteeing the safety of people?

This selection is influenced by the history of the trajectory followed by the autonomous vehicle, traffic, types of infrastructure, following good road safety practices, rules of the road and the criticality of the potential risks associated with each trajectory, such as those defined by the standard ISO 26262, for example. This choice involves the hyper planning of the refuge mode.

The behavioral choice algorithm is the last layer of intelligence that analyzes all the possible strategies and opts for the most secure and the most “comfortable” one. It will therefore choose the most suitable trajectory for the vehicle and the attendant speed.

The refuge hyper-planning module (32) calculates a refuge trajectory in order to ensure all feasible fallback possibilities in case of emergency. This trajectory is calculated from perception objects determined in accordance with the hyper-perception and hyper-planning methodology, but which are considered in this case for an alternative in refuge mode.

### Second Embodiment

The second embodiment concerns a particular case for determining the desired path for the vehicle.

The example concerns an autonomous vehicle that must be classified as “OICA” level 4 or 5 (International Organization of Automobile Manufacturers), i.e. a level of autonomy where the driver is out of the loop. The system alone, with no intervention from the driver, must steer and decide the movements of the car over any infrastructure and in any environment.

The following description concerns the safe functional architecture of the VEDECOM autonomous vehicle “over-system,” designed above an existing vehicle platform, to increase its operational safety and make it more reliable, but also to ensure the integrity of the operating information and decisions made by the intelligence of this “over-system.”

A safe architecture of the autonomous vehicle has been prepared according to the following four robustness mechanisms:
The Intrinsic redundancies of the physical calculation media as well as the processing modules;
The functional redundancies enabling the production of data and results on each function: the data and results are then conditioned by the environment and weighted by confidence levels;
The functional redundancies enabling the production of trajectory calculation results: This mechanism allows for the same function:
of verifying the coherence of the results as well as the integrity of the confidence levels;
of conditioning the data and results by the environment;
The use of centralized cross-tabulated and cross-checked information for a supervision strategy: A module examines the results in order to identify the safest result according to a decisional scheme based on the behavior of the vehicle and the environment thereof.

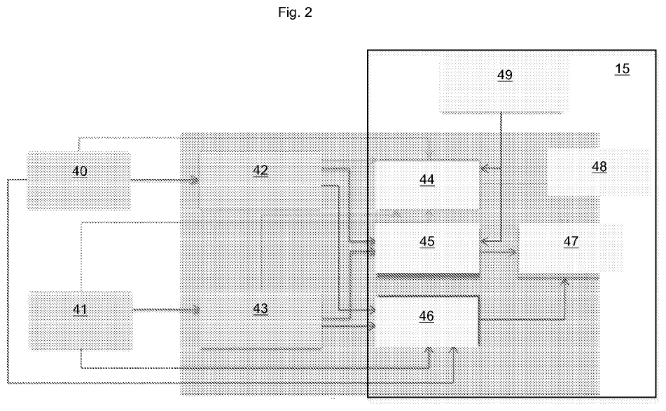

At the perception level, a generic scheme has been prepared from these principles. This is illustrated in FIG. 2.

The perception of the path is provided by four algorithms:
The path given by GPS-RTK positioning+high definition cartography,
The path given by SLAM positioning+high definition cartography,
The path given by marking (the source of which is a camera),
The path given by tracking the previous vehicle (relying on the hypothesis that the history of that vehicle's position corresponds to that of the path).

The function of Safe perception is:

1) To construct 4 desired paths from perception information from 4 sources (GPS-RTK, SLAM, Marking, Tracking).

2) To select the best information given by these four algorithms.

3) In manual mode, to prevent switching over to auto mode if the paths given by these algorithms do not have a sufficient index of confidence.

4) In autonomous mode, requesting emergency braking, associated with a request to regain control if the paths given by these algorithms do not have a sufficient index of confidence OR if the paths given by the four algorithms are incoherent with each other.

It comprises sensors (40, 41) constituting sources of information.

For example, four sources can be distinguished:
Source 1: An obstacle tracking function utilizing a Front Lidar,
Source 2: A marking detection function using a stereo camera,
Source 3: A so-called SLAM positioning function, using one or more Lidars (or four sensors associated with a merger),
Source 4: a so-called GPS positioning function, using a GPS, IMU and RTK correction.

These input functions are handled by the system (functions related to equipment manufacturers or technological components). The outputs of these four sources are therefore very heterogeneous:
Source 1 (tracking function) provides the xy position of the middle of the rear of the obstacle in the ego-vehicle reference. The obstacle is identified by an identifier number (in order to know if there is a change of target). No confidence index on the tracking is provided.
Source 2 (marking function) provides two vectors (a,b,c) corresponding to the parameters of the polynomial of the right and left marking (y=ax²+bx+c) and their confidence index, in the ego-vehicle reference.
Source 3 (SLAM function) provides the location (x,y,course) of the vehicle in the reference of the SLAM. A location confidence is given.
Source 4 (GPS positioning function) gives the location (x,y,course) of the vehicle in the absolute reference. A standard deviation of location in meters is given.

From the functions and heterogeneous outputs from the “sources” blocks (40, 41), one or more computers apply perception algorithms (42, 43) to give a homogeneous output of the object: in the example described, the object is the desired path. The desired path is given by a vector (a,b,c) corresponding to the polynomial (y=ax2+bx+c) of the path in the ego-vehicle reference.

In this part, a quick description of each perception algorithm is provided.

The “path” perception algorithm (42) by tracking utilizes the position x,y of the shield vehicle. The strong assumption is therefore that the “shield” vehicle is in the desired path of the autonomous vehicle.

The path is constructed in the following way:

1) Retrieval of the position of the tracked vehicle in the vehicle reference,

2) Positioning of the vehicle in a sliding reference,

3) Positioning of the tracked vehicle in the sliding reference,

4) Placing in memory the history (about six seconds) of the position of the tracked vehicle in the sliding reference: this history constitutes a dynamic cartography: vector [xy]_{Rsliding},

5) Location of the vehicle in the dynamic cartography,

6) Determination of the local trajectory in the dynamic cartography,

7) Switching over from the local trajectory to the vehicle reference: vector [xy]_{Rego-vehicle},

8) Polynomial interpolation of the vector [xy].

The output is therefore a “path” variable defined by the three variables (a,b,c) of the polynomial interpolation thereof.

Indeed, the marking detection algorithm (43) already provides a second degree polynomial of the white line located to the right and left of the vehicle:

Right side: y_{right}=a_{right}x²+b_{right}x+c_{right}

Left side: y_{left}=a_{left}x²+b_{left}x+c_{left}

The polynomial of the path is therefore simply the average of the 2 coefficients of the 2 polynomials:

$$y = ( \frac{{a}_{right} + {a}_{left}}{2} ) {x}^{2} + {( \frac{{b}_{right} + {b}_{left}}{2} )}_{right} x + ( \frac{{c}_{right} + {c}_{left}}{2} )$$

In the event of loss of one of the two markings by the perception algorithm (identified by a drop in the confidence level received by the safe-perception), an estimate is made by considering the width of the road (“Lane Width” cartographic input) and a symmetry of identical left side/right side form. Thus, for loss of the right marking:

$$y = {a}_{left} {x}^{2} + {b}_{left} x + \frac{( {c}_{left} + L a n e W i d t h )}{2}$$

The path perception algorithm by GPS-RTK using the data from the sensor 3 is based on:
2 base variables;
The [xy] position of the vehicle
The yaw angle of the vehicle
IMU-RTK cartography defined in an absolute reference (Lambert 93, WGS84 . . . ) containing:
   An x_p trajectory vector
   A y_p trajectory vector
   An S vector (“curvilinear distance”), deduced from the 2 previous vectors by the equation:

Sᵢ=Sᵢ₋₁+sqrt(dx_p²+dy_p²)

The cartography is produced upstream simply by rolling along the desired path and recording the x,y values given by the GPS. The strong assumption is therefore that the position given by the GPS is always of quality (<20 cm) (therefore RTK correction signal OK), which is not always the case.

Starting from this GPS position, the following steps to construct the path are:

Locating the vehicle in the IMU-RTK cartography.

Construction of the “path” trajectory, absolute reference from the map.

Change of the trajectory in the vehicle reference.

Polynomial interpolation.

The path perception algorithm by SLAM utilizing the data from the sensor 4 relies on the same principle as the GPS-RTK. The only difference pertains to the location reference: in the case of the SLAM, the x,y position, yaw, and therefore the associated cartography is given in the reference from the SLAM and not in a GPS type absolute reference.

The confidence indicators are calculated by algorithms (45).

The internal confidence only uses input or output information from the path perception algorithm by tracking; therefore here:
The xy position of the tracked vehicle.
The identifier of the tracked vehicle.
Here, the confidence is a Boolean indicator, constructed in the following way:
The confidence changes to 1 if, during “TempoTracking” seconds (the TempoTracking parameter can be set, but by default is 4 seconds), an obstacle is tracked in the axis of our vehicle AND the tracked target exists AND there has been no change of target.
Confidence changes to 0 when there is a change of target OR the tracked target no longer exists.

The “tracked target no longer exists” condition is given by reading the identifier. This identifier is equal to “−1” when no object is provided by the tracking function.

The “change of target” condition is normally identified by a change of the identifier to “−1.” Added to this are tests on the discontinuity of the position returned. (For example, if an object is at x=5 m, then at x=30 m in the next step, it can then be considered that it is not the same object). The thresholds of discontinuities have been set at 3 m per sampling period Te (Te=50 ms) in x, and 0.8 m in y by Te.

The “vehicle in the axis” condition is set at 1 if the longitudinal position x of the tracked vehicle is between 1 m and 50 m of the ego-vehicle, and if the lateral position thereof is −1.5 m<y<1.5 m.

To avoid following a fixed target, an additional activation condition consists of verifying that the absolute speed of the object is not zero, particularly when the speed of the ego-vehicle is not.

Ideally, it should be verified that the object in question is characterized as a vehicle (and not a pedestrian).

The “path” confidence by the marking is simply calculated from the 2 confidences of the 2 markings.

Path Confidence=1 if (Right MarkingConfidence>threshold OR Left MarkingConfidence>threshold)

Path Confidence=0 if (Right MarkingConfidence<threshold AND Left MarkingConfidence<threshold)

Indeed, as previously mentioned, in case of loss of one of the 2 markings by the perception algorithm, an estimate is made by considering the width of the road (“Lane width” cartographic input) and a left side/right side identical symmetry of form. Therefore, only one marking is sufficient.

The SLAM confidence is a Boolean that drops definitively to 0 when the confidence in the location of the SLAM drops below a certain threshold. Indeed, this VEDECOM SLAM is incapable of calculating a location once the SLAM algorithm is “lost.”

Moreover, the VEDECOM SLAM cannot always be activated at the start of the autonomous vehicle's route. The condition precedent should therefore only be activated when the SLAM has already been in an initialization phase (identified by a specific point on the map).

A condition related to the cartography has been added: in order for the SLAM to have a non-zero confidence, the following condition is added: the vehicle must be at least 4 meters from the path given by SLAM. To do this, the LaneShift of the vehicle is retrieved, i.e. the variable “c” of the polynomial (intercept) of the “path” perception given by the SLAM.

Like the SLAM, the confidence is a product of:
Confidence related to the location: This confidence value is 1 when the location standard deviation<threshold. Unlike the SLAM, a drop in confidence to 0 is not irreversible.
Confidence related to the cartography: This confidence value is 0 if the vehicle is more than 1.8 meters from the path given by the IMURTK. For this, the LaneShift of the vehicle is retrieved, i.e. the variable “c” of the polynomial (intercept) of the path given by the IMU-RTK “path” perception.

The external confidence is related to the environmental conditions.

The environmental conditions pertain to the following conditions:
Meteorological: rain, fog, nighttime, low angle sun, etc.
Geographical: tunnel, particular type of road, etc.

In some cases the meteorological conditions are not taken into account: In general, the demonstrations are suspended in the event of poor conditions.

The geographical conditions are taken into account in the topological cartography: in a very generic way, for each planned geographical portion in the route of the autonomous vehicle, an external confidence (Boolean 0 or 1) is provided, irrespective of the cause (tunnel, steep slope, etc.). There are therefore four columns in the topological cartography:

Tracking Mode external confidence

Marking Mode external confidence

SLAM Mode external confidence

IMU-RTK Mode external confidence

Thus, when entering a tunnel for example, and therefore positioning by GPS-RTK will not function, external confidence is set at 0 before entering the tunnel.

In general, in demonstrations when the vehicle drives several times over a portion of the route and a mode never reaches an internal confidence of 1, the external confidence is forced to 0 on this mode several meters before: this avoids changing to a mode that risks being lost shortly afterwards.

The robustness is the lesser of the internal confidence and the external watchdog confidence.

The reliability of each sensor is derived from a self-diagnostic test of the sensor, currently provided by the sensor suppliers. For example, the Continental camera provides at the output an “extended qualifier” that takes the following states:

| Value | Synonym | Description |
|---|---|---|
| 0 | Normal_Operation_Mode | Normal Operation Mode |
| 1 | Power_Up_Or_Down | Power Up Or Down |
| 2 | Sensor_Not_Calibrated | Sensor Not Calibrated |
| 3 | Sensor_Blocked | Sensor Blocked |
| 4 | Sensor_Misaligned | Sensor Misaligned |
| 5 | Bad_Sensor_Environmental_Condition | Bad Sensor Environmental |
| | | Condition |
| 6 | Reduced_Field_Of_View | Reduced Field of View |
| 7 | Input_Not_Available | Input Not Available |
| 8 | Internal_Reason | Internal Reason |
| 9 | Externa_Destortion | External Destortion |
| 10 | Beginning_Blockage | Beginning Blockage |
| 11 | Selftest | Selftest |
| 255 | Event_Data_Invalid_Or_Timeout | Event Data Invalid Or |
| | | Timeout |

A reliability calculation (46) is also performed. The reliability of the sensor is considered OK (camera reliability=1) only if extended Qualifier=0

Thus, reliability A (reliability of the path by tracking) equals 1 (status OK) if:

(LIDAR sensor reliability OK) AND (Test Watchdog OK)

reliability B (reliability of the path by marking) equals 1 (status OK) if:

(Camera sensor reliability OK) AND (Test Watchdog OK)

reliability C (reliability of the path by SLAM) equals 1 (status OK) if:

(SLAM LIDAR sensor reliability) AND (Test Watchdog OK)

reliability D (reliability of the path by IMU-RTK) equals 1 (status OK) if:

(GPS sensor reliability=1 and IMU reliability=1) AND (Test Watchdog OK)

The watchdog test involves verifying that the increment of the watchdog (information coming from the upstream perception calculator) is correctly performed.

The reliability of each algorithm is related to the reliability of each sensor source, associated with a test.

The coherence function (45) includes two types of tests:

Intrinsic coherence

Coherence by comparison with the other objects.

An objective of intrinsic coherence is to verify the pertinence of the object itself. For example, an intrinsic coherence test of an obstacle verifies that the object seen is well within the visible zone of the sensor.

One possible test would be to verify that over the last N seconds, the path given by an algorithm is close to the path of the vehicle history. For example, the LaneShift (variable “c” of the polynomial of the path) of the algorithm can be checked and verified that it is close to 0 over the last 5 seconds.

The objective is to output a Boolean indicating if the “path” given by one algorithm is coherent with the path given by another one. With 4 paths given by 4 algorithms A, B, C, D, there are therefore 6 Booleans to be calculated: Aft AC, AD, BC, BD, CD.

The comparison of two paths is done roughly by comparing the courses of the algorithms. Specifically, the comparison is achieved as follows:

1) For the “path” polynomial given by each algorithm, the desired course is calculated for three different time horizons (0.5 s, 1 s, 3 s)

The desired course is equal to atan (desired LaneShift/distance to the defined time horizon).

1) Then the difference of the three courses given by two different “path” algorithms is calculated, and they are all averaged

2) They are all filtered on a low-pass filter set at 2 seconds (which represents an average of about 2 seconds), then divided by a “CourseCoherence_deg” reference threshold with a default parameter of 10°.

3) If they give a result of more than 1, then the two paths are considered as non-coherent.

4) This test is performed 6 times for the 6 pairs of possible paths AB, AC, AD, BC, BD, CD.

The decision block (47) performs the final choice of the path, as a function of the confidences, coherences, reliability indexes and performance index. In the event of failure, of a confidence index that is too low, of incoherence between the actual path and the proposed choices, an emergency braking decision can be requested.

The general principle is as follows:
1) A robustness, corresponding to the lesser of the confidence and the reliability index, is calculated.
2) The algorithms of paths (A: Tracking, B: Marking, C: SLAM, D: GPS-RTK) receive a priority index defined in the “default ranking” (independent of the confidence, coherence or reliability). This ranking is related to rules of expertise concerning performance in particular.

If Default Ranking=[D, A, C, B], the four algorithms are then classified by order of priority: (1: D: GPS-RTK, 2: A: Tracking, 3: C: SLAM, 4: B: Marking)
3) All the attributes related to the algorithms (confidence, coherence) are also ranked: In the example, the coherence D-A becomes the coherence 1-2
4) A sequential logic chooses the algorithm as a function of:
   a. Confidence
   b. Coherence: For example, to change from the path of an algorithm 2 to the path of the algorithm 3, the coherence 2-3 must be OK
   c. The “Algo1Prio” variable: if this index equals 1, the algorithm defined as priority in “Default Ranking” will always be favored (example: D the GPS-RTK). If this index equals 0: the algorithm currently used will be given priority (in the example, if 3: C: SLAM, and 1: D: GPS-RTK comes back confident, then it still remains at 3: C: SLAM).
5) If there is a general lowering of confidence, or of incoherence between the path of the current algorithm and the path of the possible choices, then the decision-making activates an emergency braking flag. In manual mode, this results in the prevention of changing to autonomous mode.
6) Concerning the last function, the choice of the algorithm, referenced as the priority index (1: the highest priority to 4 as the lowest priority), returns to the initial ranking index (A: Tracking, B: Marking, C: SLAM, D: GPS-RTK).

At the input of this block (47), there is:

The internal/external confidence in the 4 algorithms (A: Tracking, B: Marking, C: SLAM, D: GPS-RTK), i.e. c′A,c′B,c′C,D

The reliability index of the 4 algorithms (A: Tracking, B: Marking, C: SLAM, D: GPS-RTK), i.e. fA,fB,fC,fD

The robustness c″ is the lesser of the 2, therefore;

c″X=min(c′X,fX).

The expertise rules consist of preliminary rules imposed from the VEDECOM expertise, in this case, on the path construction algorithms.

Thus, it is known from experience that:
The path given by GPS-RTK provides the best performance among the four algorithms (accuracy and dynamics). However, there are frequent losses in urban mode.
The path given by SLAM induces a certain noise on the steering (localization noise), particularly at low speed. And its accuracy, and therefore its associated performance, is all the greater when the environment is changing. (Urban better than highway).
The tracking assumes we have a vehicle “of confidence,” but has the advantage of being able to be used anywhere, and even make the change of path.
The marking, given by the Continental camera, is now the least efficient algorithm, and in particular is unusable below a radius of curvature of 150 m.

Since for the moment autonomous vehicles are being used in “shuttle” mode, experience achieved by traveling the route with the four modes makes it possible to know which is the most overall efficient mode for a given route.

Also, expertise shows that it is always better to give priority to a particular algorithm based on the history recorded in real time in an information base (48) (even if it means abandoning the use of the current algorithm in order to go back to the priority algorithm). However, other people, in order to avoid algorithm transitions (which can cause micro-movements of the steering wheel compared to a safe and comfortable performance), prefer to minimize these transitions by retaining the current algorithm as much as possible (even if the better performing algorithm is again usable).

Two parameters related to the expertise have therefore been constructed:
1) “Ranking by priority” vector, size 4, which ranks the four algorithms (A: Tracking, B: Marking, C: SLAM, D: GPS-RTK) by order of priority.
   a. For an urban type route for example, there is “Default ranking”=[C, D, A, B]: the SLAM, efficient in urban setting, is favored, then the IMURTK, then tracking, then marking.
   b. For a highway type route, for example, the “Default ranking”=[D, B, A, C]: the GPS-RTK, then marking are favored, then tracking and SLAM.
2) “Algol Prio” parameter:
   a. If this index equals 1, the algorithm defined as priority in “Default ranking” will always be favored (example: C the SLAM if “Default ranking”=[C, D, A, B]).
   b. If this index equals 0: priority will be given to the current algorithm (if “Default ranking”=[C, D, A, B]), if it is at A: Tracking, and if C: SLAM comes back confident, then it still remains at A: Tracking).

The “Transfer Algo Number→Priority Number” will change the numbering of the confidence and coherence variables: referenced by default as (A: Tracking, B: Marking, C: SLAM, D: GPS-RTK), these variables are, via this transfer function, numbered as (1: Highest priority algorithm, 2: 2nd priority algorithm, 3: 3rd highest priority algorithm, 4: Lowest priority algorithm).

For example, if “Default Ranking”=[D, B, A, C], then the confidence “A” becomes the confidence “3,” and the B-A coherence becomes the 2-3 coherence.

The sequential logic is a Stateflow system having the following inputs:
The 4 confidences (numbered according to the order of ranking by priority): therefore “confidence_1” is the confidence of the priority algorithm.
The 6 coherences (numbered according to the order by ranking of priority): therefore “coherence 1_4” is the coherence between the path of the priority algorithm with that of the lowest priority.

The two outputs are:
1) The number of the chosen algorithm (numbered according to the order of ranking by priority). Thus, if Number_algo_used=2, this means that the algorithm chosen for the desired path is the second priority algorithm (for example the GPS-RTK (D) if “Default ranking”=[C, D, A, B]).
2) The “emergency braking” Boolean. If this variable equals 1, emergency braking of the autonomous vehicle is activated. In manual mode, this variable is used to inhibit activation of the autonomous mode.

### Vehicle in Manual Mode

In manual mode, the objective of the function will be to determine the best algorithm possible when the transition is going to be made to autonomous mode.

More importantly, however, the function must prevent the change to autonomous mode if no algorithm has a sufficient confidence index (not zero here).

In general, this diagram favors the return to mode 1, i.e. the choice of the priority algorithm. Only the confidence indexes are taken into account. The coherences are not, because in the case of manual mode, and unlike autonomous mode, a poor coherence between two paths will not have an impact (such as swerving).

Thus, a priority 3 algorithm will only be selected if the confidence of the algorithms 1 and 2 are zero.

If all the algorithms have a zero confidence, then there is a change to the Safety: EmergencyBraking=1 mode. However, there will not specifically be emergency braking on the vehicle (because it is in manual mode), but only a prevention of changing to autonomous mode (If EmergencyBraking=1 AND If manual mode, then change to autonomous mode is prohibited).

### Vehicle in autonomous mode

Example considering: “Default ranking”=[C, D, A, B]) or [SLAM, GPS-RTK, Tracking, Marking).

MODE_AUTO_1 represents the schema when the current algorithm is the priority algorithm (for example SLAM (C) if “Default ranking”=[C, D, A, B]).

In the example:

IF the confidence of the SLAM=1, it remains in SLAM

IF the confidence of the SLAM changes to 0, another mode (2, 3, 4) will be selected:

A change to mode 2 is made (D: GPS-RTK) if the confidence of the path in GPS-RTK equals 1 AND if the path given by the SLAM and that of the GPS-RTK are coherent (coherence_1_2=1)

ELSE: A change is made directly from mode 1 to mode 3 (A: Tracking), IF it is not possible to change to GPS-RTK (cf. condition in the previous sentence) AND if the confidence of the path in Tracking equals 1 AND if the path given by the SLAM and the path from the Tracking are coherent

ELSE: A change is made directly from mode 1 to mode 4 (B: Marking), IF it is not possible to change to GPS-RTK AND IF it is not possible to change to Tracking AND if the confidence of the path by Marking equals 1 AND if the path given by the SLAM and the one from the Marking are coherent

ELSE: a change Is made to emergency braking.

It is assumed in the example that a change is made to mode 2 (therefore D: GPS-RTK)

MODE_AUTO_2 represents the schema when the current algorithm is the second priority algorithm (therefore GPS-RTK if “Default ranking”=[C, D, A, B]).

There are two situations according to the “AlgoPrio1” parameterization.

IF “AlgoPrio1=0” AND IF the confidence of the path by GPS-RTK=1, it remains in GPS-RTK.

IF “AlgoPrio1=1” AND IF the confidence of the path by GPS-RTK=1, a change is still made to priority 1 mode (therefore returned to SLAM) IF confidence of the SLAM=1 AND if the path given by the SLAM and the one from GPS-RTK are coherent (coherence_1_2=1).

In the following, the same principle is used as the one previously given.

IF the confidence of the GPS-RTK changes to 0, another mode (3, 4) will be selected:

A change is made from mode 2 to mode 3 (A: Tracking) IF the confidence of the path in Tracking equals 1 AND if the path given by the GPS-RTK and the path from the Tracking are coherent

ELSE: a change is made directly from mode 2 to mode 4 (A: Marking), if it is not possible to change to tracking AND if the confidence of the path by Marking equals 1 AND if the path given by the GPS-RTK and the path from Marking are coherent

ELSE a change is made to emergency braking.

In general, the choice of the path is based on a sequential diagram based on:
The confidence in the path of each algorithm
The coherence between the paths given by pairs of algorithms
The “AlgoPrio1” parameter which is equal to 1, will favor the transitions to return to the priority mode. If it is equal to 0, it will limit the transitions in order to remain on the algorithm currently used by the vehicle.

The Transfer Priority Number→Algo Number function just makes the transfer between ranking by priority (1: the highest priority Algo, 2: the second highest priority Algo, 3: the third highest priority Algo, 4: the lowest priority algorithm) and the default ranking (A: Tracking, B: Marking, C: SLAM, D: GPS-RTK).

Thus, if “Default ranking”=[D, B, A, C] and the sequential logic block has chosen the third highest priority algorithm, then the algorithm chosen is (A: Tracking).

1. System for steering and autonomous vehicle comprising a plurality of sensors of different natures, computers executing computer programs for determining items of information regarding delegated driving as a function of the data delivered by said sensors, and
at least one arbitration module comprising at least one computer executing a computer program to decide the safest functional selection of one of said items of information regarding delegated driving as a function of a plurality of items of information calculated as a function:
of dynamic data comprising part at least of the items of information comprised of:
confidence levels of each of said items of information of delegated driving,
a coherence of variables associated with said delegated items of information
reliability of hardware and software of components of said system
of climatic and/or historical data comprising at least part of the items of information comprised of:
a driving history of the vehicle,
environmental conditions,
and a decision processing for the arbitration of a safe behavior of steering of the vehicle.

2. The system for steering an autonomous vehicle according to claim 1, wherein the computer program for deciding on the selection of one of the said items of information regarding delegated driving further takes into account items of information representative of safety principles.

3. The system for steering an autonomous vehicle according to claim 1, wherein the system comprises a plurality of arbitration modules for processing groups of sensors and associated computers, comprising at least:
position sensors of the vehicle,
identification sensors of the route on which the vehicle is moving,
dynamic and static obstacle sensors, and
sensors of infrastructures and signaling,
and a module for constructing a plurality of trajectories of movement of the vehicle based on the information transmitted by the said arbitration modules.

4. The system for steering an autonomous vehicle according to claim 1, wherein the arbitration module further receives items of information providing a means of functional merger of the items of information from the results from the different perception and processing modules.

5. The system for steering an autonomous vehicle according to claim 1, wherein the system further comprises decision-making means for determining a refuge trajectory activated in the event of impossibility of calculating a nominal trajectory.

6. Method of steering an autonomous vehicle, comprising:
steps of acquiring of a plurality of items of information by sensors;
steps of processing said items of information acquired in order to determine items of information of delegated driving;
steps of acquiring environment conditions,
steps of calculating items of information representative of:
levels of confidence of each of said item of information of delegated driving,
a coherence of variables associated with the said delegated items of information
reliability of hardware and software components of said system;
decision-making steps from optimal delegated driving items of information in terms of reliability and safety of persons, as a function of a plurality of items of information from the result of the calculation steps of the said items of information representative of the driving history of the vehicle and safety rules of conduct.
